(19) United States
(12) Patent Application Publication
(10) Pub. No.: US 2015/0004410 A1
(43) Pub. Date: Jan. 1, 2015

(54) THREAD AND FABRIC FOR INSECT SCREENS

(71) Applicants: TRITTEC AG, Wittenforden (DE); SAATI DEUTCHLAND GMBH, Raesfeld (DE)

(72) Inventors: Robert Kruger, Trittau (DE); Norbert Gernemann, Rhede (DE); Carsten Brauer, Bocholt (DE); Rolf Bruggemann, Gescher (DE)

(21) Appl. No.: 14/369,666

(22) PCT Filed: Dec. 18, 2012
(86) PCT No.: PCT/EP2012/076004

§ 371 Date: Jun. 27, 2014

(30) Foreign Application Priority Data
Dec. 29, 2011 (DE) 102011057150.7

(51) Int. Cl. D01F 8/14; D01F 8/06; D03D 9/00; E06B 9/52

(52) U.S. Cl. CPC D01F 8/14; E06B 9/52; D01F 8/06; D03D 9/00; D10B 2321/021; D10B 2401/021; D10B 2331/04
USPC 428/364

(57) ABSTRACT

In order to provide a thread (4, 5) for producing fabrics (2) for insect screens (1), comprising a core, the core having a coating (11) which comprises a heat-activatable adhesive for integrally bonding to itself or to other threads of the fabric (2), and said core having a higher melting point than the adhesive, to provide a fabric (2) for insect screens (1) with a stitch/web structure (7), comprising warp threads (4) and weft threads (5) which are interconnected at node points (6) by means of adhesives, to provide an insect screen (1) comprising a frame (3) and a fabric (2) which is clamped by means of the frame (3), and to provide a method for producing fabrics (2) for insect screens (1), comprising the steps of a) providing threads (4, 5) as warp threads (4) and weft threads (5), b) weaving a fabric (2) using the warp threads (4) and weft threads (5), and c) heating the fabric (2) to a temperature that is higher than the melting point of the adhesive and lower than the melting point of the core so as to create integral bonds between the warp threads (4) and the weft threads (5) at the node points (6) thereof, which fabric can be processed into a transparent fabric (2) for insect screens (1) in a particularly efficient manner, it is proposed that that the coating (11) comprises hydrophobic repellents.

### CROSS-REFERENCE TO RELATED APPLICATIONS

This application is the national phase under 371 of International Application No. PCT/EP2012/076004, filed Dec. 18, 2012, which claims priority to German Application No. 102011057150.7, filed Dec. 29, 2011, which applications are hereby incorporated herein by reference in their entireties and from which applications priority is hereby claimed.

The present invention relates to a thread for producing fabrics for insect screens, comprising a core, the core having a coating comprising heat-activatable adhesives for integrally bonding to itself or to other threads of the fabric, and the core having a higher melting point than the adhesive.

In addition, the present invention relates to a fabric for insect screens that has a stitch/web structure, said fabric comprising warp threads and weft threads that are interconnected at node points by means of adhesives.

The present invention further relates to an insect screen comprising a frame and a fabric that is clamped by the frame.

Finally, the present invention relates to a method for producing fabrics for insect screens, comprising the steps of a) providing threads as warp threads and weft threads, b) weaving a fabric using the warp threads and weft threads and c) heating the fabric to a temperature that is higher than the melting point of the adhesive and lower than the melting point of the core in order to produce integral bonds between the warp threads and the weft threads at the node points thereof.

Insect screens are used behind windows that can be opened. They allow the window to be opened, for example for ventilation purposes, but do not allow insects to enter the room. Generally, a fabric is fixed in a suitable frame which is mounted behind the window frame. In the context of the present invention, fabrics are understood to be woven products which are produced manually or mechanically and consist of at least two thread systems that are intertwined in particular at right angles or approximately at right angles. In general, the fabric as a whole needs to let as much light and air pass through as possible while preventing insects from doing so, and to also be as invisible as possible.

A fabric of the type mentioned at the outset is known for example from WO 2004/088078 A2. This prior art proposes rigidly connecting the fabric at the node or crossing points between the warp threads and weft threads. A bonding agent is proposed for bonding. Alternatively, it also proposed to bond the threads at the node points by melting with heat or connecting by means of ultrasound energy. A drawback of this disclosure is that the adhesive does not have the resistance to ultraviolet radiation that is necessary for the application.

WO 2003/067015 A 1 discloses another insect screen having a fabric of the type mentioned at the outset. The fabric disclosed therein is provided with a thin coating which makes the fabric appear matt black and also does not give much strength at the node points of the threads.

DE 2009 007 7 48 A 1 discloses a fabric for insect screens, during the production of which the warp threads and the weft threads are bonded together by means of polyester resin in an aqueous solution. The resultant fabric is very stable and is very permeable to light and air. However, during the production process the polyester resin closes a considerable number of stitches of the fabric, thereby making the closed stitches clearly visible to the naked eye. Fabrics with closed stitches are considered to be substandard goods in terms of their desired application, i.e. as insect screens that are as invisible as possible.

JP 2000 290 856 A describes a foldable fabric for insect screens for attaching to doors or windows. The fabric has a stitch/web structure and comprises warp threads and weft threads which are interconnected at node points by means of adhesives. The threads are formed as bicomponent threads having a core and a coating. The coating contains a high-density polyethylene as the heat-activatable adhesive, the polyethylene having a lower melting point than the core. During production, the fabric is heated, whereby the warp threads and the weft threads are welded together at the node points thereof. If the fabric is installed in a humid ambient climate, the stitches of the fabric close as a result of moisture condensation on the threads. The insect screens constructed from this fabric are clearly visible and disrupt the view of an observer looking through the screen.

Therefore, the object of the present invention is to provide a thread, a fabric, an insect screen, and a method for producing fabrics for insect screens of the type mentioned at the outset, so as to avoid the drawbacks associated with the prior art.

The visibility of fabrics for insect screens depends essentially on the stitches closing during production of the fabric, on liquid deposits on the threads of the fabric when installed, and on the color of the threads.

According to the present invention, the object in terms of the thread is achieved by a thread of the type mentioned at the outset, the coating of which comprises hydrophobic repellents.

According to the invention, the thread is very advantageously automatically equipped with the adhesive needed for the processing thereof. The thread according to the invention allows for bonding, limited to certain areas, of warp threads and weft threads at node points of the fabric. Global application of an adhesive in the form of an aqueous solution, which can cause stitches to close, is avoided according to the invention. By selecting, according to the invention, a heat-activatable adhesive, the thread, in a deactivated, non-adhesive state, as is the case according to the invention at all natural ambient temperatures, can be handled without difficulty. The adhesive is activated in a conceivably simple manner, i.e. by heating. The temperature can thus be used to control with great accuracy the point at which the thread according to the invention is adhesively activated or deactivated. For this purpose, it has proven particularly advantageous according to the invention for the core to have a higher melting point than the adhesive. As a result, the adhesives can be melted and therefore adhesively activated, but without the core melting or substantially softening, in order to prevent tearing of the thread during bonding. Since the temperature is a very easily controllable process variable, the thread and also the fabric can be produced industrially in a simple and therefore cost-effective manner. Included in the invention are coatings which completely envelop the thread, but also those which are formed as strips which are parallel to the longitudinal axis of the thread or as rings which have a finite width and extend along the circumference of the thread. Even discrete, punctiform coating patterns are provided according to the invention. The thread according to the invention can be particularly efficiently processed to form a fabric for insect screens that is as invisible as possible.

The coating according to the invention very advantageously comprises hydrophobic repellents. Repellents of this type prevent atmospheric moisture and drops of water from settling on the thread, thereby keeping said thread dry. If the thread is used for its intended purpose according to the invention, namely for producing fabrics for insect screens, the hydrophobic repellents prevent stitches from being closed by drops of water, so the fabric remains invisible even with high levels of atmospheric moisture or condensation.

The object in terms of the thread is, however, also achieved according to the present invention by a thread of the type mentioned at the outset, the coating of which comprises colorants. By adding colorants, the color of the thread can be defined during production thereof. It is generally known that fabrics for insect screens are considered less bothersome to a person looking through them if they are dark-colored. In this respect, it is particularly advantageous if the thread from which the fabric for insect screens is produced is a dark color.

In a particularly advantageous embodiment of the present invention, the core contains a polyester, in particular polyethylene terephthalate (PET), and the coating contains a polyolefin, in particular polyethylene (PE), as an adhesive. PET and PE are able to be integrally bonded together. Consequently, the coating is non-releasably connected to the core so that the coating does not flake off, for example in the case of severe bending or kinking of the thread. The function according to the invention of the thread is thus, in principle, maintained over an endless period of time. In addition, the combination of materials PET and PE fulfils the above condition very well in terms of the melting points, since PET has a melting point of over 250 oc but PE melts as low as at 130° C. A process temperature for bonding the warp threads and the weft threads of the fabric can therefore advantageously be selected from a range between the two melting points. The combination of materials in this embodiment of PET and PE is extremely suitable for producing the threads according to the invention by means of coextrusion of core and coating.

In a particularly advantageous embodiment of the present invention, the coating contains a fluorinated polyolefin, in particular polytetrafluoroethylene (PTFE), as a repellent. It has been found that PTFE is particularly suitable both for application to the core and in terms of its hydrophobic effect.

So that the PE, which is transparent per se, does not appear whitish when the thread is subjected to high mechanical stress, it is alternatively or additionally provided according to the invention that the coating has soot as the colorant. PE enriched with soot particles appears black to the eye and is thus less visible as a fabric woven with PE-coated threads than a milky white fabric. Additionally, the soot particles stabilize the threads according to the invention against ultraviolet radiation, and this is important for extending the service life of fabrics, which are exposed to the sun, of insect screens.

According to the invention, it is very advantageously provided that the thread can be produced by means of coextrusion of the core and coating. The primary shaping method of extrusion is exceptionally suitable for producing continuous products such as threads. In the coextrusion used according to the invention, a first extruder for example feeds PET into the nozzle of the extrusion machine and a second extruder, which is independent of the first extruder, feeds PE into the nozzle, the PET string and the PE string being joined in the nozzle and pulled together though a tool in a continuous manner.

It is additionally provided in an embodiment of the invention that adhesive agents, in particular cyanoacrylate, are arranged between the core and the coating. Depending on the specific PET/PE combination and on a resultant bond strength between the core and the coating of the thread, it can be advantageous when the thread is under particularly high mechanical stress to increase the connection strength by means of adhesive agents, so as to prevent damage to the coating. Damage of this type, for example microcracks, would lead to the PE, which is generally transparent, being able to be perceived as a milky white color and the fabric for insect screens would no longer be invisible.

Furthermore, it has proven particularly advantageous according to the invention if the core is thinner than 0.20 mm, more particularly exactly 0.15 mm. Such a thread thickness is optimum both in terms of the low visibility of the fabric, as is fundamentally desired, and for the strength of the fabric required in this case.

According to the present invention, the object in terms of the fabric is achieved by a fabric of the type mentioned at the outset, in which at least some of the warp threads and/or weft threads are designed as threads according to the invention. It goes without saying that the advantages described in relation to the threads according to the invention also extend to the fabric according to the invention. The thin and stable threads according to the invention allow a resistant fabric to be woven having a relatively large stitch width compared with the thickness of the threads. Such a thread is very permeable to light and is thus almost invisible. For a fabric to qualify as an effective protection device against insects, the stitch width has to be so small as to prevent insects, which are to be kept out, from slipping through. In particular, during use of the insect screen warp threads and weft threads should not be allowed to be displaced relative to one another, since otherwise the maximum permissible stitch width for effectively blocking insects may be exceeded at least in certain regions. In the fabric which is constructed from threads according to the invention and is thus itself a part of the invention, the warp threads and weft threads are very advantageously bonded together at the node points thereof and the stitch width of the fabric is permanently set. The possibility of subsequent displacement of individual threads within the fabric is excluded. Owing to the threads which are integrally bonded a plurality of times, the fabric according to the invention is stable and dimensionally accurate, which results in particularly simple handling and easy processability. In addition, the fabric according to the invention is very permeable to light and air and is virtually invisible.

In a particularly advantageous embodiment of the invention, it is provided that the fabric has a stitch width of from 0.7 mm to 1.7 mm, in particular 1.1 mm. A stitch width selected from this range is advantageously below the slip-through size that prevents bothersome insects from passing through the fabric, while sufficient air and light permeability is ensured at the same time.

According to the present invention, the object in terms of the insect screen is achieved by an insect screen of the type mentioned at the outset, in which the fabric is designed as the fabric according to the invention. The aforesaid advantages of the thread according to the invention are reflected in the advantageous properties of the fabric according to the invention, which for its part has a direct effect on the insect screen according to the invention. With insect screens, the fabric is generally the component which is at most risk of failure and which leads to malfunction of the entire insect screen. The particularly resistant fabric affords, in a very advantageous manner, the insect screen according to the invention a stability and durability that are considerably greater than in conventional insect screens. There are thus fewer rejects during production and assembly of the insect screens according to the invention. The insect screen according to the invention is invisible when installed.

According to the present invention, the object in terms of the method is achieved according to a method of the type mentioned at the outset, at least some of the warp threads (4) and/or weft threads (5) being designed as threads according to the invention and said method comprising a step d) of hydrophobisation of the fabric (2). Using the threads according to the invention allows the extremely advantageous fabric according to the invention to be produced on its merits. Nevertheless, in order to create the integral bond between warp threads and weft threads at the node points thereof, which is necessary for this purpose, the adhesive must be activated. The adhesive is activated by heating. The method according to the invention very advantageously provides a step whereby the fabric having the threads according to the invention is heated, the adhesive is activated as a result, and integral bonds between the warp threads and the waft threads at the node points thereof are generated. The method according to the invention is consequently very well suited for producing stable fabrics having set stitches for insect screens. Since the method according to the invention dipping the fabric in pools containing liquid adhesive or other coating agents, according to the invention the stitches are very advantageously prevented from closing. Moreover, the method according to the invention proceeds particularly efficiently and economically, since a large number of integral bonds are created at the same time and in process terms, heating a fabric is a process step which can be implemented in a very simple manner, without the need for additional materials or strict safety measures for example.

It has proven particularly advantageous according to the invention that during step c) the fabric is heated to a temperature that is higher than the melting point of the adhesive and lower than the melting point of the core. This activates the adhesive in order to allow the advantageous integral bonds to be produced. However, since the melting point of the core is not reached in this method step, said core remains stable and the fabric thus remains intact and can be handled.

Once the fabric has been heated to melt the warp threads and weft threads at the node points thereof, there can still be regions of said threads, in particular at said node points, which do not have hydrophobic repellents and thus promote disadvantageous settling of atmospheric moisture or drops of water. In order to eliminate this drawback, the method according to the invention very advantageously provides for total hydrophobisation of the woven and bonded fabric, preferably subsequently, in particular as a final step. This method step amounts to complete sealing of the fabric and ensures maximum protection against condensation of atmospheric moisture or drops of water on the fabric, so that said fabric remains invisible to the greatest possible extent even in such adverse ambient conditions.

The invention will now be described by way of example in a preferred embodiment with reference to the drawings, further advantageous details being inferable from the figures of the drawings.

### BRIEF DESCRIPTION OF THE DRAWINGS

FIG. 1 shows as insect screen according to the invention having a fabric according to the invention made from a plurality of threads according to the invention,

FIG. 2a is a schematic sectional view of the fabric according to the invention, in a bonded state, along the line II-II labelled in FIG. 1, and

FIG. 2b is an enlargement of a detail of the fabric according to the invention in the region B labelled in FIG. 2a.

### DETAILED DESCRIPTION OF THE PREFERRED EMBODIMENTS

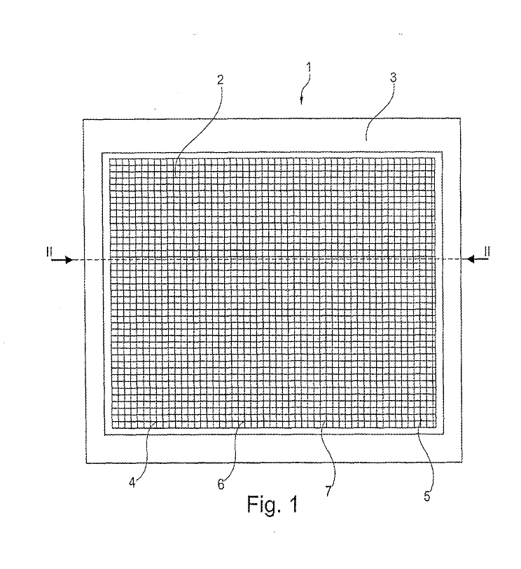

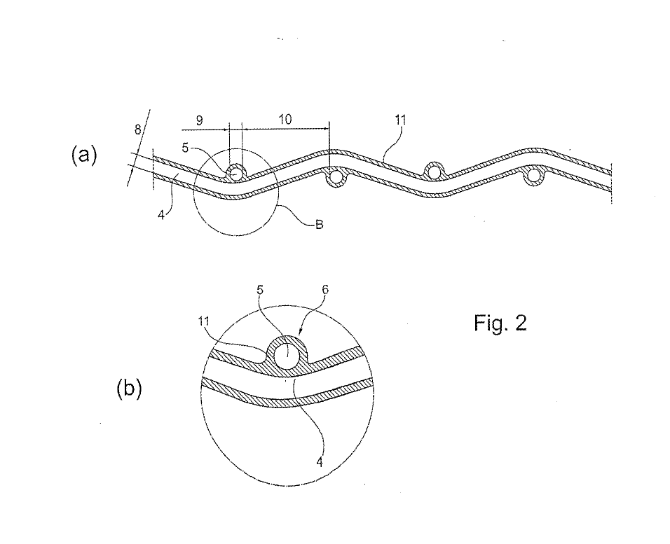

FIG. 1 is a schematic view of an insect screen 1 according to the invention. The insect screen 1 consists substantially of a fabric 2 according to the invention which is set into a frame 3 in a generally known manner that is not described in more detail. The fabric 2 is constructed from warp threads 4, which extend vertically in FIG. 1, and weft threads 5, which extend orthogonally to the warp threads 4. As is generally known, the terms warp thread 4 and weft thread 5 relate to the production process of weaving. In the context of the present invention, however, it is unimportant which threads are warp threads 4 or weft threads 5, or which were which during the production of the fabric 2. At each crossing point, the warp threads 4 form node points 6 together with the weft threads 5. In this way, the fabric 2 according to the invention in FIG. 1 has a web structure with stitches 7. The warp threads 4 and the weft threads 5 are bicomponent threads comprising a core and a coating 11. In the particularly advantageous embodiment shown here, the core contains polyethylene terephthalate (PET) and the coating 11 contains polyethylene (PE). The construction of the warp threads 4 and weft threads 5 will be described in more detail below with reference to FIG. 2a and FIG. 2b.

FIG. 2a is a part of a schematic sectional view of the fabric 2 according to the invention, in a bonded state, along the line 11-11 labelled in FIG. 1. The thread thickness 8 of the warp threads 4 is 0.15 mm. The thread thickness 9 of the weft threads 5 is also 0.15 mm. The stitch width 10 of the stitches 7 is 1.1 mm. The stitches 7 are formed as squares. Consequently, the open area per stitch 7 is accordingly 1.21 mm2. In the context of the invention, rectangular or any other stitch shapes are also conceivable. It can also be clearly seen in FIG. 2a that the warp threads 4 and the weft threads 5 consist substantially of two components, i.e. of a core and a coating 11 surrounding the core. The coating 11 is preferably applied both over the entire peripheral surface of the core and to the warp threads 4 and the weft threads 5. The threads 4, 5 can advantageously be produced by coextrusion. The coating 11 contains a heat-activatable adhesive (PE in this case) and hydrophobic repellents, for example polytetrafluoroethylene (PTFE). The PE and PTFE regions of the coating 11 are thus spatially separate from one another. In an alternative or further embodiment of the invention, the coating 11 comprises colorants, for example soot particles, in order to improve the visual properties of the thread 4, 5 according to the invention, inasmuch as a black thread 4, 5 colored with soot is less visible than threads of other colors.

FIG. 2b is a schematic view of an enlargement of a detail of the fabric according to the invention in the region labelled B in FIG. 2a. The warp threads 4 and the weft threads 5 are integrally bonded together, i.e. joined with glue, in the region of the node points 6 thereof. The adhesive PE required therefor is provided by the coating 11. Owing to the joining with glue, the coatings 11 of all the warp threads 4 and weft threads 5 bond to form a one-piece coating arrangement which carries all the warp threads 4 and weft threads 5 within itself as stabilizing elements. Since the bonds of warp threads 4 and weft threads 5 are limited to the node points 6 and do not project into the stitches 7 or even close entire stitches 7, the stitch width 10 is practically not reduced at all. Therefore, the permeability of the fabric 2 to light and air is maintained according to the stitch width 10.

Following the steps known from the prior art of a) providing threads 4, 5 as warp threads 4 and weft threads 5, b) weaving a fabric 2 using the warp threads 4 and weft threads 5 and c) heating the fabric 2 to a temperature that is higher than the melting point of the adhesive and lower than the melting point of the core so as to create integral bonds between the warp threads 4 and the weft threads 5 at the node points 6 thereof, in order to produce the fabric 2 for an insect screen 1 the method according to the invention provides a step d) of hydrophobisation of the fabric 2, at least some of the warp threads 4 and/or weft threads 5 being threads 4, 5 according to the invention. The heating causes the adhesive of the threads 4, 5 to be activated. With PET as the core and PE as the adhesive of the threads 4, 5, the fabric woven from these threads 4, 5 is heated to approximately 140° C., whereby the warp threads 4 and the weft threads 5 are bonded together a plurality of times. Since the adhesive is bonded to the core of the threads 4, 5 and is not applied by dipping the fabric 2 into a bath containing liquid adhesive, the possibility of stitches 7 closing is very advantageously excluded. Once the adhesive has been deactivated as a result of cooling of the fabric 2 to below 100 oc, no further bonds can be created, although it goes without saying that the bonds that have already been created remain in place. Following method step c), the fabric 2 is considerably stronger and very advantageously has set node points so that the warp threads 4 and the weft threads 5 can no longer be displaced relative to one another and a maximum permissible stitch width 10 for effectively shutting out bothersome insects is not exceeded under any circumstances. To prevent the fabric 2 from falling apart during step c) owing to melting of the core of the threads 4, 5, care must be taken to always keep said threads lower than the melting point of the core (PET in this case). Step d) of hydrophobisation of the fabric 2 brings about subsequent total hydrophobisation of the fabric 2, in particular in regions where the hydrophobic repellents have been covered by the adhesives during melting of the coating 11. This method step amounts to complete sealing of the fabric 2 and ensures maximum protection against condensation of atmospheric moisture or drops of water on the fabric to ensure that said fabric remains invisible to the greatest possible extent even in adverse ambient conditions. Overall, it should be noted that the fabric 2 according to the invention can be produced particularly efficiently using the method according to the invention.

### LIST OF REFERENCE NUMERALS

1. Insect screen
2. Fabric
3. Frame
4. Warp thread
5. Weft thread
6. Node point
7. Stitch
8. Thread thickness
9. Thread thickness
10. Stitch width
11. Coating

What is claimed is:

1. Thread (4, 5) for producing fabrics (2) for insect screens (1), comprising a core, the core having a coating (11) which comprises heat-activatable adhesives for integrally bonding to itself or to other threads of the fabric (2), and the core having a higher melting point than the adhesive, characterized in that the coating (11) comprises hydrophobic repellents.
